(19) United States
(12) Patent Application Publication
(10) Pub. No.: US 2017/0174185 A1
(43) Pub. Date: Jun. 22, 2017

(54) System and Method for Responding to an Error from a Camera on a Vehicle

(71) Applicant: Bendix Commercial Vehicle Systems LLC, Elyria, OH (US)

(72) Inventor: Justin R. Miller, Elyria, OH (US)

(21) Appl. No.: 14/974,406

(22) Filed: Dec. 18, 2015

(51) Int. Cl. B60S 1/48; G06K 9/03; G06K 9/00

(52) U.S. Cl. CPC B60S 1/485; G06K 9/00791; G06K 9/03

(57) ABSTRACT

Responding to an error from a camera on a vehicle includes identifying the error as being associated with an obstructed visual image received by the camera. If the error is associated with the obstructed visual image: at least one vehicle accessory is either activated or continued to be activated for removing an obstruction on a window of the vehicle; after the activation or the continued activation of the at least one vehicle accessory, a determination is made whether the error persists for a predetermined error time period or a predetermined duration; if the error persists for the predetermined error time period, up to a predetermined number of times i) the activation or continued activation is repeated and ii) the determination is repeated. If the error persists after the predetermined number of times or the duration, the at least one vehicle accessory is deactivated and an operator of the vehicle is alerted that the error persists.

### BACKGROUND

The present invention relates to a vehicle including a camera. It finds particular application in conjunction with controlling at least one vehicle accessory for clearing an obstruction in the camera's view and will be described with particular reference thereto. It will be appreciated, however, that the invention is also amenable to other applications.

It is becoming more common to include visual detectors (e.g., cameras) on vehicles. The visual detectors may be located inside the vehicle (e.g., inside a cab of a truck) and obtain image data for views exterior to the vehicle by “looking” through a window of the vehicle. Visibility limitations may occur if moisture and/or other debris accumulates on either an interior portion or an exterior portion of the window at which the camera is pointed. The accumulated moisture and/or debris obstructs the view of the camera.

The camera may enter into a fault or degraded performance state when the optical/visual field becomes obstructed. If the window through which the camera is obtaining the exterior view is the front windshield (or other visually transparent surfaces such as side windows), actions may be taken to clear or remove the obstruction.

The present invention provides a new and improved apparatus and method for clearing or removing obstructions from a window when the optical/visual field of a camera becomes obstructed.

### SUMMARY

In one aspect of the present invention, it is contemplated that responding to an error from a camera on a vehicle includes identifying the error as being associated with an obstructed visual image received by the camera. If the error is associated with the obstructed visual image: at least one vehicle accessory is either activated or continued to be activated for removing an obstruction on a window of the vehicle; after the activation or the continued activation of the at least one vehicle accessory, a determination is made whether the error persists for a predetermined error time period or a predetermined duration; if the error persists for the predetermined error time period, up to a predetermined number of times i) the activation or continued activation is repeated and ii) the determination is repeated. If the error persists after the predetermined number of times or the duration, the at least one vehicle accessory is deactivated and an operator of the vehicle is alerted that the error persists.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a representation of a vehicle including at least one camera in accordance with one embodiment of an apparatus illustrating principles of the present invention;

FIG. 2 illustrates a component representation of the vehicle in accordance with one embodiment of an apparatus illustrating principles of the present invention; and

FIG. 3 is an exemplary methodology for responding to an error code from the camera in accordance with one embodiment illustrating principles of the present invention.

### DETAILED DESCRIPTION OF ILLUSTRATED EMBODIMENT

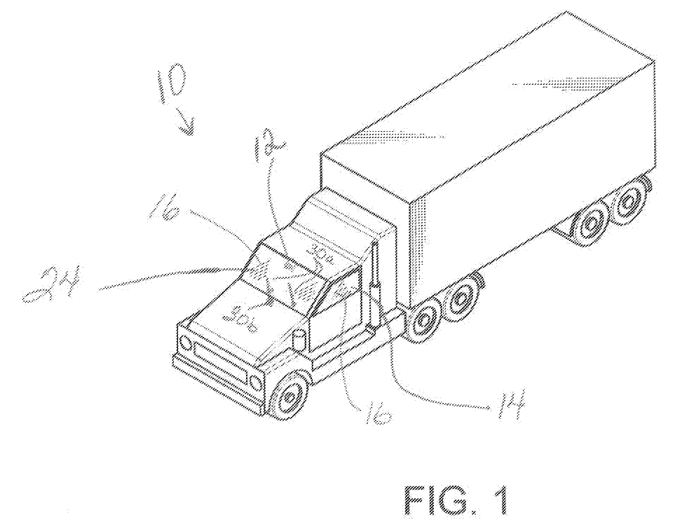

With reference to FIG. 1, a vehicle 10 includes at least one visual detector 12 (e.g., camera) as part of, for example, safety systems on the vehicle 10. In one embodiment, at least one of the cameras 12 is located within a driver compartment 14 (e.g., cab) of the vehicle 10 and obtains image data for views exterior to the vehicle 10 by “looking” through a window 16 and/or reflections in a side mirror of the vehicle 10. Visibility limitations may occur if moisture and/or other debris accumulates on either an interior portion or an exterior portion of the window 16 at which the camera 12 is pointed. The moisture and/or debris may accumulate to the point of obstructing the view of the camera 12 to the exterior portion of the window 16.

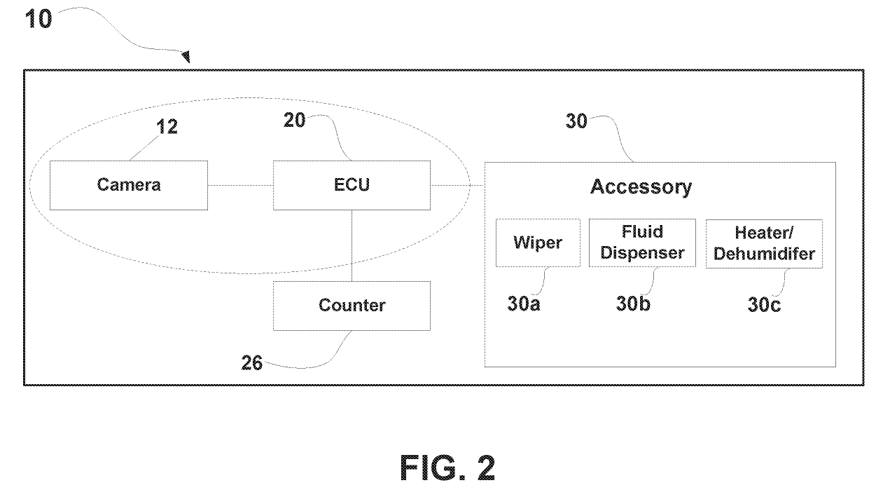

With reference to FIGS. 1 and 2, the camera 12 electronically communicates with an electronic control unit 20 (ECU) (e.g., a controller) via, for example, a communication bus 22 on the vehicle 10. As illustrated by the dashed line around the camera 12 and the ECU 20 in FIG. 2, it is contemplated in one embodiment that the camera 12 and the ECU 20 are included as a single component. Other embodiments, in which the camera 12 and the ECU 20 are separate components are also contemplated. The camera 12 enters into a fault or degraded performance state when the optical/visual field becomes obstructed because of moisture and/or debris accumulation on the window 16. If the window 16 through which the camera is obtaining the exterior view is a front windshield window 24, actions may be taken to clear or remove the obstruction.

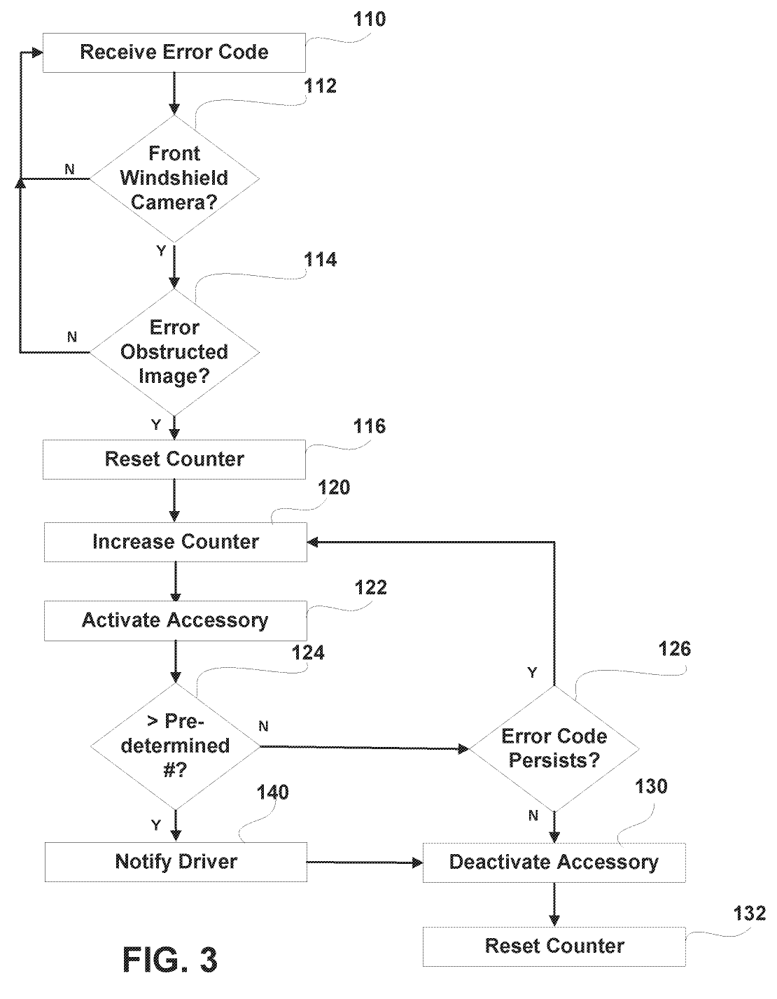

With reference to FIG. 3, an exemplary methodology for responding to an error code from the camera is illustrated. As illustrated, the blocks represent functions, actions and/or events performed therein. It will be appreciated that electronic and software systems involve dynamic and flexible processes such that the illustrated blocks and described sequences can be performed in different sequences. It will also be appreciated by one of ordinary skill in the art that elements embodied as software may be implemented using various programming approaches such as machine language, procedural, object-oriented or artificial intelligence techniques. It will further be appreciated that, if desired and appropriate, some or all of the software can be embodied as part of a device's operating system.

With reference to FIGS. 1-3, in a step 110, the error code from the camera 12 is received in the ECU 20 on the vehicle 10. In a step 112, a determination is made by the ECU 20 whether the error code is from one of the cameras 12 obtaining an image through the front windshield 24. If it is determined in the step 112 that the image is not from one of the cameras 12 obtaining an image through the front windshield 24, control returns to the step 110; otherwise, control passes to a step 114. In the step 114, a determination is made by the ECU 20 whether the error code is associated with an obstructed visual image. It is contemplated that the at least one camera 12 generates the error code indicating the visual image is obstructed if at least a predetermined portion (e.g., 30%) of the image is blurred and/or obstructed. If it is determined in the step 114 that the error code is not associated with an obstructed visual image, control returns to the step 110; otherwise, control passes to a step 116. In the step 116, a counter 26 is reset (e.g., set to zero) by the ECU 20. Although the counter 26 is illustrated as a separate component communicating with the ECU 20 via the communication bus 22, it is also contemplated that the counter 26 is included as part of the ECU 20.

The counter 26 is then increased by the ECU 20, for example, by one (1) in a step 120. Then, in a step 122, at least one vehicle accessory 30 is activated (e.g., automatically activated) by the ECU 20 for a predetermined error time period (e.g., ten (10) seconds) or a predetermined number of times (e.g., five (5)) as an attempt to remove the obstruction on the windshield 24. In one embodiment, the activating step 122 includes activating (e.g., automatically activating, manually activating by a switch, etc.) at least one of a windshield wiper 30a, a washer fluid dispenser 30b, and a heater/dehumidifier 30c. The windshield wiper 30a, the washer fluid dispenser 30b, and the heater/dehumidifier 30c are collectively referenced as the at least one vehicle accessory 30.

The windshield wiper 30a and/or washer fluid dispenser 30b are activated (e.g., automatically activated) by the ECU 20 for wiping and/or dispensing fluid on an exterior of the windshield 24 of the vehicle 10. When activated, the washer fluid dispenser 30b acts to spray washer fluid on the exterior of the windshield 24. The windshield wiper 30a then wipes the windshield 24, which acts to spread the fluid across the path of the windshield wiper 30a on the windshield 24. The fluid works with the windshield wiper 30a to remove the obstruction from the windshield 24. When activated, the heater/dehumidifier 30c acts to at least one of warm the interior and exterior of the windshield 24 and dehumidify the interior of the windshield 24.

As is commonly understood, the windshield wiper 30a and washer fluid dispenser 30b are positioned to wipe and dispense fluid, respectively, on the exterior portion of the windshield 24 of the vehicle 10. The heater/dehumidifier 30c acts to blow warm and/or dehumidified air on the interior portion of the windshield 24 of the vehicle 10. The warm and/or dehumidified air blown on the interior portion of the windshield 24 acts to also warm the exterior portion of the windshield 24.

In one embodiment, it is contemplated that if the counter 26 is one (1), only the windshield wiper 30a is activated by the ECU 20 in the step 122 for attempting to remove the obstruction. If the counter is two (2), both the windshield wipers 30a and the washer fluid dispenser 30b are activated by the ECU 20 in the step 122. If the counter is greater than or equal to three (3), the windshield wipers 30a, the washer fluid dispenser 30b, and the heater/dehumidifier 30c are activated by the ECU 20 in the step 122. The heater/dehumidifier 30c is positioned inside the vehicle cab 14 for warming and dehumidifying the interior of the windshield 24 and warming the exterior of the windshield 24 to, for example, melt ice and/or snow on the exterior of the windshield 24. It is contemplated that activating the washer fluid dispenser 30b to spray fluid on the exterior of the windshield 24 also may act to melt ice and/or snow on the exterior of the windshield 24.

After activating the at least one accessory 30 in the step 122 for the predetermined error time period or the predetermined number of times, a determination is made by the ECU 20 in a step 124 whether the counter is greater than a predetermined number (e.g., five (5)). If it is determined in the step 124 that the counter is not greater than the predetermined number, control passes to a step 126 for determining by, for example, the ECU 20 if the error code persists (e.g., if the obstruction remains on the windshield 24) after the predetermined error time period. If it is determined in the step 126 that the error code still persists after the predetermined error time period, control returns to the step 120 for increasing the counter 26. Otherwise, if the error code no longer persists after the predetermined error time period, control passes to a step 130.

In the step 130, the at least one vehicle accessory 30 is deactivated by the ECU 20. Optionally, the counter is reset by the ECU 20 in a step 132.

If, in the step 124 it is determined that the counter 26 is greater than the predetermined number, it is determined that the obstruction on the windshield 24 has not been removed after the at least one vehicle accessory has been activated the predetermined number of times for the predetermined error time period. Therefore, control passes to a step 140. In the step 140, an operator (e.g., driver) of the vehicle 10 is notified by the ECU 20 that the obstruction on the windshield 24 has not been removed. For example, a light is illuminated on a dashboard of the vehicle, an audible signal is activated in the vehicle cab 14 and/or a textual message is displayed on the dashboard.

Control then passes to the step 130 for deactivating the at least one vehicle accessory 30 by the ECU 20. Since it is assume at this point that the obstruction on the windshield 24 will not be removed by activating the at least one accessory 30, along with alerting driver that the obstruction on the windshield 24 has not been removed, the at least one vehicle accessory 30 is deactivated in the step 130.

The ECU 20 acts as a means for identifying the error as being associated with an obstructed visual image received by the camera, a means for activating at least one vehicle accessory for removing an obstruction on a window of the vehicle, a means for determining if the error persists for a predetermined error time period, a means for continuing to activate the vehicle accessory and repeating the activation, a means for repeating the determination up to a predetermined number of times, a means for deactivating the vehicle accessory, and a means for alerting an operator of the vehicle that the error persists. The ECU 20 also acts as a means for activating the at least one vehicle accessory based on a number of times the activation has been continued or repeated.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/We claim:

1. A method for responding to an error code from a camera on a vehicle, the method comprising:
identifying the error as being associated with an obstructed visual image received by the camera;
if the error is associated with the obstructed visual image:
one of activating and continuing activation of at least one vehicle accessory for removing an obstruction on a window of the vehicle;
after the one of the activation and the continued activation of the at least one vehicle accessory, determining if the error persists for a predetermined error time period; and
if the error persists for the predetermined error time period, up to a predetermined number of times or a predetermined duration i) repeating the one of activating and continuing activation step and ii) repeating the determining step; and
if the error persists after the predetermined number of times or the duration:
deactivating the at least one vehicle accessory; and
alerting an operator of the vehicle that the error persists.

2. The method for responding to an error code from a camera on a vehicle as set forth in claim 1, wherein the one of activating and continuing activation step includes:
activating the at least one vehicle accessory based on a number of times or duration the one of activating and continuing activation step has been performed.

3. The method for responding to an error code from a camera on a vehicle as set forth in claim 2, wherein the activating the at least one vehicle accessory based on a number of times or duration the one of activating and continuing activation step has been performed includes:
activating only a windshield wiper the first time the one of activating and continuing activation step is performed;
activating only the windshield wiper and a washer fluid dispenser a second time the one of activating and continuing activation step is performed; and
activating the windshield wiper, the washer fluid dispenser and a heater/dehumidifier after the second time the one of activating and continuing activation step is performed.

4. The method for responding to an error code from a camera on a vehicle as set forth in claim 1, further including:
identifying the visual image received by the camera as obstructed if less than a predetermined portion of an object identified in the visual image is correlated to a known object.

5. The method for responding to an error code from a camera on a vehicle as set forth in claim 1, wherein the activating step includes:
in response to a control signal or a switch activation, activating at least one of a windshield wiper and a washer fluid dispenser.

6. The method for responding to an error code from a camera on a vehicle as set forth in claim 1, wherein the activating step includes:
in response to a control signal or a switch activation, activating a mirror heater/dehumidifier.

7. The method for responding to an error code from a camera on a vehicle as set forth in claim 1, further including if the error is associated with the obstructed visual image:
deactivating the at least one vehicle accessory at the end of the predetermined error time period.

8. The method for responding to an error code from a camera on a vehicle as set forth in claim 1:
further including before the first activating step:
setting at least one of a counter and a timer to zero; and
further including prior to each time the activation step is performed:
at least one of increasing the counter by one and determining if the timer is expired.

9. The method for responding to an error code from a camera on a vehicle as set forth in claim 8, further including if the error does not persist for the predetermined error time period after any of the determining steps:
deactivating the at least one vehicle accessory.

10. The method for responding to an error code from a camera on a vehicle as set forth in claim 1, further including if the error does not persist for the predetermined error time period after any of the determining steps:
deactivating the at least one vehicle accessory.

11. The method for responding to an error code from a camera on a vehicle as set forth in claim 1, wherein the alerting step includes:
illuminating at least one of a light on a dashboard of a vehicle, activating an audible signal, and displaying a textual message on the dashboard.

12. The method for responding to an error code from a camera on a vehicle as set forth in claim 1, further including:
setting the predetermined number of times to 5.

13. A controller for responding to an error from a camera on a vehicle, the controller being adapted to:
identify the error as being associated with an obstructed visual image received by the camera;
if the error is associated with the obstructed visual image, the controller being adapted to:
transmit a control signal to at least one of activate and continue to activate at least one vehicle accessory for removing an obstruction on a window of the vehicle;
after the one of activation and continued activation of the at least one vehicle accessory, determine if the error persists for a predetermined error time period; and
if the error persists for the predetermined error time period, up to a predetermined number of times or a predetermined duration i) repeat the one of activation and continued activation and ii) repeat the determination; and
if the error persists for the predetermined error time period after the predetermined number of times or the predetermined durations, the controller being adapted to:
deactivate the at least one vehicle accessory; and
transmit a signal to alert an operator of the vehicle that the error persists.

14. The controller as set forth in claim 13, wherein the controller is adapted to:
activate the at least one vehicle accessory based on a number of times one of the activation and the continued activation has been performed.

15. The controller as set forth in claim 14, wherein the controller is adapted to:
activate only a windshield wiper the first time the one of activation and the continued activation is performed;
activate only the windshield wiper and a washer fluid dispenser a second time the one of the activation and the continued activation is performed; and
activate the windshield wiper, the washer fluid dispenser and a heater/dehumidifier after the second time the one of the activation and the continued activation is performed.

16. The controller as set forth in claim 13, wherein the controller is further adapted to:
identify the visual image received by the camera as obstructed if less than a predetermined portion of an object identified in the visual image is correlated to a known object.

17. The controller as set forth in claim 13, wherein the activation includes:
in response to a control signal or a switch activation, activate at least one of a windshield wiper and a washer fluid dispenser.

18. The controller as set forth in claim 13, wherein the activation includes:
in response to a control signal or a switch activation, activate a windshield heater/dehumidifier.

19. The controller as set forth in claim 13, wherein if the error is associated with the obstructed visual image, the controller is further adapted to:
deactivate the at least one vehicle accessory prior to the predetermined error time period.

20. The controller as set forth in claim 13, wherein:
before the at least one vehicle accessory is activated the first time, the controller being adapted to:
set at least one of a counter and a timer to zero; and
each time the at least one vehicle accessory is activated, the controller being adapted to:
increase the counter by one or activate the timer for a predetermined duration.

21. The controller as set forth in claim 20, wherein if the error does not persist for the predetermined error time period after any of the determinations, the controller is further adapted to:
deactivate the at least one vehicle accessory.

22. The controller as set forth in claim 13, wherein if the error does not persist for the predetermined error time period after any of the determinations, the controller is further adapted to:
deactivate the at least one vehicle accessory.

23. A controller for controlling at least one vehicle accessory, the controller being adapted to:
receive an error code from a vehicle camera;
set a counter to zero;
if the error code is associated with an obstructed visual image, until one of i) the error code ceases within a predetermined error time period after activation or continued activation of the at least one vehicle accessory and ii) the counter is greater than or equal to a predetermined count, the controller being adapted to repeatedly:
increment a count of the counter;
one of i) activate the at least one vehicle accessory and ii) continue the activation of the at least one vehicle accessory based on the count of the counter; and
if the error code ceases within the predetermined error time period and the count of the counter is less than the predetermined count, the controller being adapted to:
deactivate the at least one vehicle accessory; and
if the error code does not cease within the predetermined error time period and the count of the counter is greater than or equal to the predetermined count, the controller being adapted to:
deactivate the at least one vehicle accessory; and
alert an operator of the vehicle that the error persists.

24. The controller as set forth in claim 23, wherein if the error code ceases within the predetermined error time period and the count of the counter is less than the predetermined count, the controller being further adapted to:
reset the counter to zero.

25. The controller as set forth in claim 23, wherein the controller is further adapted to:
alert the operator of the vehicle via an audible signal.

26. The controller as set forth in claim 23, wherein to activate the at least one vehicle accessory, the controller is further adapted to:
only activate a windshield wiper if the count is one;
only activate the windshield wiper and a washer fluid dispenser if the count is two; and
automatically activate the windshield wiper, the washer fluid dispenser, and a heater/dehumidifier if the count is greater than two.

27. A controller for responding to an error from a camera on a vehicle, comprising:
means for identifying the error as being associated with an obstructed visual image received by the camera;
if the error is associated with the obstructed visual image, the controller further including:
means for activating at least one vehicle accessory for removing an obstruction on a window of the vehicle;
after activation of the vehicle accessory, means for determining if the error persists for a predetermined error time period; and
if the error persists for the predetermined error time period, i) one of means for continuing to activate the vehicle accessory and repeating the activation and
ii) means for repeating the determination up to a predetermined number of times; and
if the error persists for the predetermined error time period after the determination is repeated the predetermined number of times, the controller further including:
means for deactivating the vehicle accessory; and
means for alerting an operator of the vehicle that the error persists.

28. The controller for responding to an error from a camera on a vehicle as set forth in claim 27, further including:
means for activating the at least one vehicle accessory based on a number of times the activation has been continued or repeated.
